(19) United States
(12) Patent Application Publication
(10) Pub. No.: US 2011/0132710 A1
(43) Pub. Date: Jun. 9, 2011

(54) SHIFTABLE CLUTCH DEVICE, IN PARTICULAR WITH DISC-TYPE CONFIGURATION, DRIVE TRAIN FOR A HYBRID SYSTEM, AND VEHICLE

(75) Inventor: Kai Schenck, Offenburg (DE)

(73) Assignee: Schaeffler Technolgies GmbH & Co. KG, Herzogenaurach (DE)

(21) Appl. No.: 12/999,435

(22) PCT Filed: May 22, 2009
(86) PCT No.: PCT/DE2009/000731

§ 371 Date: Feb. 3, 2011

(30) Foreign Application Priority Data
Jun. 19, 2008 (DE) 10 2008 028 850.0
Aug. 11, 2008 (DE) 10 2008 037 326.5

(51) Int. Cl. F16D 33/18; F16D 25/0635; F16D 47/06

(52) U.S. Cl. 192/3.33; 192/85.61; 192/48.3

(57) ABSTRACT

The invention relates to a shiftable clutch device (10), in particular in disc configuration, including at least a first clutch component (10E) and a second clutch component (10A), each clutch component including friction surface bearing and/or friction surface forming elements (1E, 1A, 1.1), configured to be brought into at least indirect operative engagement through a shifting device (14) that is loadable with a pressure medium through a pressure cavity (8), wherein devices for generating a cooling oil flow to the friction surface bearing and/or friction surface forming elements (1E, 1A, 1.1.) of the particular clutch components (10E, 10A) are provided in an “open” functional condition of the shiftable clutch device (10).

### FIELD OF THE INVENTION

The invention relates to a shiftable clutch device, in particular in disc configuration, including at least a first clutch component and a second clutch component, wherein both clutch components include friction surface bearing and/or friction surface forming elements, wherein the clutch components are configured to be brought into at least indirect operative engagement through a shifting device, which is loadable with a pressure medium through a pressure cavity.

The invention furthermore relates to a drive train for a hybrid system, in particular for application in vehicles including at least two drive machines, which are configured to be coupled with additional transmission units through a force transmission device, wherein a device for providing/disconnecting the force flow between the first drive machine and the drive train is provided, the device including a shiftable clutch device with a first clutch component and a second clutch component, which are configured to be brought into operative engagement at least in an indirect manner through a shifting device that is actuatable through a pressure medium.

The invention furthermore relates to a vehicle with a drive train for a hybrid system.

### BACKGROUND OF THE INVENTION

In known drive trains with a shiftable clutch device that is actuatable through a pressure medium for selectively connecting or disconnecting a drive engine, in particular an internal combustion engine from a drive train configured as a disc clutch, the disc clutch is actuate through at least one piston element through a pressure cavity associated with the piston element, wherein the pressure cavity is loadable with pressure medium, and also designated as piston cavity. In an alternative embodiment, a nozzle or aperture is provided for connecting between the piston cavity that is loadable with pressure medium and the remaining clutch cavity enveloping the friction surface bearing and/or friction surface forming elements. This means that in the first case, there is no cooling oil stream provided for cooling the friction surface bearing and/or friction surface forming elements, or the cooling oil flow forming through the aperture or nozzle between the pressure cavities, thus connected with one another and loadable with pressure medium, in particular fluid, is not proportional to an actual coolant requirement. This leads to an increased thermal loading for the clutch and to a reduced availability and it also leads to energy losses.

In hybrid systems, in which at least two different drive machines are provided, through which the driving can be performed alternatively or jointly, wherein at least one drive machine is configured to function as a drive machine in a first operating mode, and as a machine for converting brake energy into a different form of energy for intermediary storage and/or as drive energy for additional consumers in a second operating mode, such clutch devices which are provided as devices for disconnecting/providing a force flow between the first drive machine and the drive train are not operable without substantial additional complexity for providing the required cooling.

### BRIEF SUMMARY OF THE INVENTION

A hybrid system of this type is illustrated e.g. in the printed document DE 103 10 831 A1, FIG. 30. This document discloses a force transmission device, which is disposed between two drive machines and a subsequent consumer configured as a transmission. In order to completely decouple the first drive machine from the drive train, a device for connecting/disconnecting a force flow is provided between the drive machine and the force transmission device, wherein the device is configured as a shiftable clutch device, which is also designated as engine clutch or disconnect clutch. The second drive machine is configured as an electrical machine, whose rotor is connected torque proof with the force transmission device. The force transmission device includes at least one startup element, preferably configured as a hydrodynamic component and a device for at least partially circumventing the force flow through a hydrodynamic component. The hydrodynamic component is preferably configured as a frictional shiftable clutch device which is also designated as lockup clutch and facilitates bypassing the hydrodynamic component in the force flow. The subsequent transmission which is typically configured as a variable speed shiftable transmission is characterized by a plurality of shift elements that are actuated through a pressure medium. The following operating modes are considered basic operating modes of a drive train of this type in traction operation, which are modifiable through plural sub-operating modes:
Driving, in particular motorized driving with a force flow from the first drive machine, in particular the internal combustion engine, through a first and/or second power path of the force transmission device with a closed device for disconnecting/providing the force flow between the first drive machine and the force transmission device; and
Driving, in particular electrical driving, with a force flow from the second drive machine, in particular the electrical machine, through a first and/or second power path of the force transmission device for an open/disconnected device for disconnecting/implementing the force flow between the first drive machine and the force transmission device.

In the operating mode “electric driving”, the internal combustion engine is stopped and the electrical machine is running. Thus, there is a differential speed at the shiftable clutch device, in particular between the particular clutch components, which generates friction heat. In this drive mode, the pressure cavity for loading the shifting device of the shiftable clutch device is only supplied with low pressure or no pressure, so that only a small cooling oil flow with very small cooling power can be provided.

In the operating mode “driving with internal combustion engine”, the internal combustion engine and also the electrical machine rotate. The wet clutch is closed, there are no speed differences and consequently no friction losses therein, and no heat development. On the other hand, however, when using an aperture or nozzle, the maximum coolant flow flows since the maximum oil pressure is provided in the piston cavity in this operating mode. This means that also when using a cooling aperture for cooling the clutch, the cooling oil flow is always inversely proportional to the actual cooling requirement.

In the German application publication DE 10 2006 040 117 A1, furthermore a hybrid drive unit for a motor vehicle to be installed between an internal combustion engine and a vehicle transmission is described, wherein the hybrid drive unit includes an electrical machine with a rotor and stator and is operable as a motor or generator. Radially within the electric machine, at least one shiftable clutch device is disposed, and the vehicle transmission includes a transmission input shaft and a transmission housing. A cooling medium, e.g. cooling oil, is essentially supplied and removed for cooling the clutch through a central coolant supply from the transmission to the hybrid drive unit. A substantially closed cooling medium loop is connected to the central cooling medium supply, wherein a pressure balancing cavity is provided in the coolant loop in the portion of the clutch, wherein the coolant loop can be flowed through by the cooling medium of the cooling medium loop. The cooling medium is provided on both sides of the piston element. Also here, the supply with cooling medium is substantially a function of the pressure conditions at the piston element.

Thus, it is the object of the invention to provide a drive train for a hybrid system, in which the cooling required for the particular operating modes and the cooling power of the shiftable clutch device actually available for providing/disconnecting the force flow between the first drive machine and the drive train substantially correspond to one another. Thus, the solution according to the invention shall be characterized by low design complexity.

The object is achieved through the features of claims 1, 17 and 24. Advantageous embodiments are described in the dependent claims.

A shiftable clutch device configured according to the invention, in particular configured as a friction wet clutch in disc construction including at least a first and a second clutch component, which include friction surface bearing and/or friction surface forming elements, which can be brought at least into indirect operative engagement through a shifting device, which can be loaded with operating medium through a pressure cavity is characterized in that devices for generating a coolant oil flow to the friction surface bearing and/or friction surface forming elements of the particular clutch components are provided in an “open” functional condition of the shiftable clutch device.

When using the shiftable clutch device in hybrid systems, thus in a particularly advantageous manner, the friction heat generated at the clutch components, in particular the particular friction surface bearing and/or friction surface forming elements, rotating with a relative speed with reference to one another, can be removed for an open clutch device and a driven second clutch component in a controlled manner, so that the thermal loading can be kept relatively low.

The devices for generating a coolant oil flow thus include at least a flow connection between the pressure cavity, which can be loaded with pressure medium anyhow in particular for closing the shiftable clutch device at the shifting device, in particular a piston element, and the surroundings of the particular clutch components and devices for controlling the fluid flow through the flow connection thus provided. The operating medium supply and/or conduction system associated with the shiftable clutch is thus configured and designed, so that the pressure cavity is never completely without pressure, also in an open condition of the shiftable clutch device, and thus the open end position of the piston element, but a low pressure is always provided. The low pressure is provided by a minimum filling with a liquid. The minimum pressure furthermore has advantages when a reloading of the shifting device of the shiftable clutch device is required.

Thus, the shifting device includes at least one piston element which is supported axially moveable at one of the two clutch components and/or an element connected therewith, wherein the piston element forms a pressure cavity that is loadable with pressure medium. The flow connection is provided through at least one opening, in particular a pass through opening in the piston element or a recess in the pressure cavity in particular the wall of the piston element, preferably in the piston base, wherein the pass through cross section of the opening is controllable. Thus at least one, preferably a plurality of openings is provided which are offset from one another in circumferential direction the device for controlling the fluid flow as a function of the position of the piston element can include at least one controllable valve device, in particular a throttle which is integrated in the connection and controlled according to the operating pressure in the piston element. This however requires active control.

On the other hand an additional preferred embodiment is characterized in that an element for closing a particular opening or recess is provided which is preferably formed by an element of the shiftable clutch device, preferably a friction surface bearing or friction surface forming element of the clutch device. In a particularly advantageous embodiment this function is performed by the edge disc. A separate valve device can be omitted and the clutch configuration which is provided anyhow is used for changing the pass through cross section.

In order to assure a completely self acting adaptation of the coolant media flow that can be generated through the connection the particular opening, in particular the pass through opening opens in a preferred embodiment in a portion of the piston surface at the piston element, wherein the piston surface forms friction surface bearing and/or friction surface forming elements and the control of the pass through cross section is provided by controlling by the contact force applicable to the effective piston surfaces at the clutch components. This means when the contact force increases the pass through opening is closed based on the pressing to an element of the shiftable clutch device in particular the end- or edge disc. No additional measures are required within the flow connection and the cooling media flow is already reduced when closing the clutch while the cooling media flow is released by releasing the pass through opening cross section according to the position of the piston element. Only the geometry of the pass through opening has to be adapted to the size of the required cooling media flow in the opening end position of the clutch device. This solution represents a particularly cost effective embodiment which is simple to implement and which can also be retrofitted in existing clutch devices.

The piston element of the shifting device can thus be axially supported at the second clutch component or at a component connected torque proof with the second clutch component, wherein the piston element forms a pressure cavity that is loadable with pressure medium. The second clutch components thus preferably includes an outer disc support which is disposed at a rotatable housing component or forms an integral unit therewith, wherein the piston element is supported axially moveable at the housing or a wall connected torque proof with the housing or an element connected torque proof with the housing.

In an alternative embodiment the piston element can also be supported axially moveable at the first clutch component or at a component connected torque proof with the first clutch component.

In order for the piston element to be loadable with lower pressure in the “open” position and thus in the “open” functional condition of the shiftable clutch device without leading to a closure of the shiftable clutch device, a device for generating a actuation force oriented opposite to the pressure force through the pressure chamber, in particular a preloading force is provided. In the simplest case the device includes a preloading element which is effective at the piston element and which is supported at the clutch elements or at a connection element connected torque proof with the connection element. Depending on the association with the shifting device, the preloading element includes a compression or tension spring device which preferably directly loads the shifting device of the actuatable clutch device.

A drive train for a hybrid system in particular for use in vehicles with at least two drive machines which are configured to be coupled through a force transmission device with additional transmission units, wherein a device for providing/disconnecting the force flow between the first drive machine and the drive train is provided, advantageously includes a shiftable clutch device with a first clutch component and a second clutch component which can be brought at least indirectly into operative engagement with one another through a shifting device that is actuatable through a pressure medium and which is configured according to one of the claims 1-16. When the driving is solely performed through the second drive machine the maximum cooling power can thus be provided in a particularly advantageous manner, while the maximum cooling power decreases according to the reduced requirement when closing the shiftable clutch device.

There is a plurality of options with respect to the configuration of the force transmission device itself. The force transmission device preferably includes at least one start up element, particularly preferably a hydrodynamic component and a device for circumventing the hydrodynamic component in the force flow, wherein a particularly advantageous manner the force transmission device and the shiftable clutch device can be supplied with pressure medium from a common operating medium control and conduction system. The force transmission device can be configured at least as a two or three channel unit. In the first case the force transmission device includes at least two connections, a first connection coupled with an operating cavity of the hydrodynamic component and a second connection defined by a housing at the outer circumference of the hydrodynamic component and coupled with a cavity that is fillable with operating medium. When configured as a three channel unit a third connection is provided which is coupled with a cavity which is associated with the piston element and loadable with pressure medium at will.

Thus, the input of the force transmission device can be formed by a housing bell enclosing at least the force transmission device, preferably also the shiftable clutch device configured as an engine clutch and walls formed by the housing bell or connected torque proof there with between the shiftable clutch device and the force transmission unit for defining the pressure cavities of the shiftable clutch device and the force transmission device. Thus, the number of components can be kept small and the function can be concentrated to few components.

The drive train according to the invention is suited in a particularly advantageous manner for use in hybrid systems, whose first drive machine is formed by an internal combustion engine and whose second drive machine is formed by a machine which can be operated as a motor and as a generator. Other drive concepts for implementing the first and/or the second drive machine are also conceivable.

### BRIEF DESCRIPTION OF THE SEVERAL VIEWS OF THE DRAWING

The solution according to the invention is subsequently described with reference to drawing figures, wherein:

FIGS. 1a and 1b illustrate the configuration and function of a clutch device according to the invention with reference to an axial sectional view; and

FIG. 2 illustrates a detail from an axial sectional view of a drive train according to the invention with a shiftable drive train according to the invention.

### DETAILED DESCRIPTION OF THE INVENTION

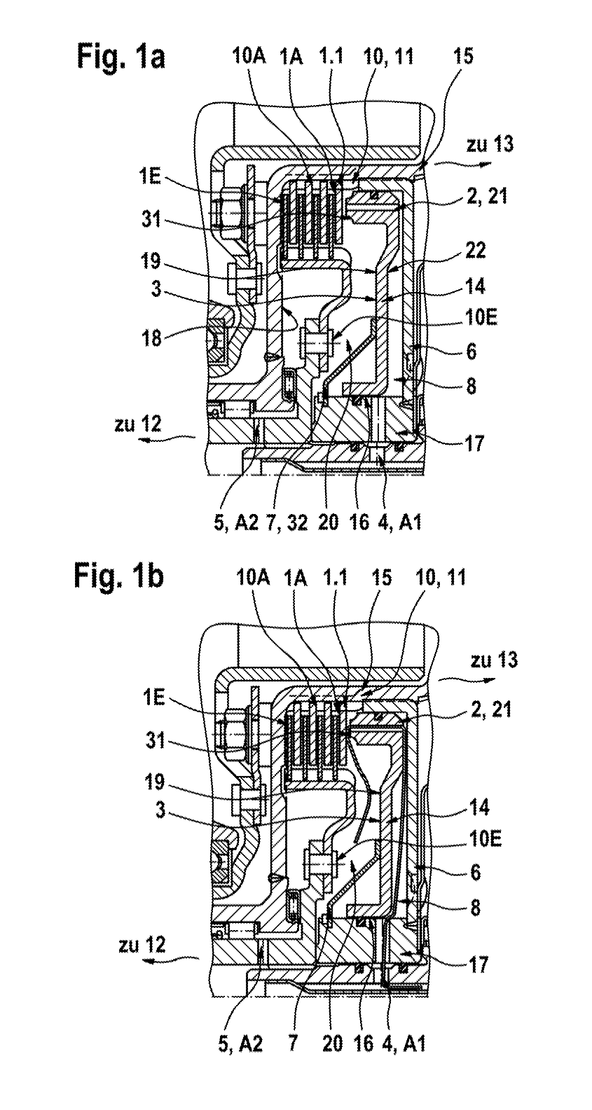

FIG. 1a illustrates the configuration and the function of a shiftable clutch device 10 according to the invention in a simplified schematic view, in particular in the form of a friction locked wet clutch 11 as it can be used between a first drive machine 12 and the drive train 13 in vehicles, with reference to an axial sectional view through the shiftable clutch device. The wet clutch 11 is configured in disc construction, in particular in lamellar disc construction, including a first clutch component 10E which is connectable at least indirectly with the first drive machine 12 and a second clutch component 10A which is coupled with the remaining drive train towards the wheels. The first and the second clutch component 10E, 10A can be brought into operative engagement with one another at least indirectly through a shifting drive 14. The first and the second clutch component 10E, 10A thus include at least one disc support and discs 1E and 1A disposed thereon, so that they are moveable in axial direction and respectively associated with the first and the second clutch component 10E and 10A, wherein the discs function respectively as friction surface bearing or friction surface forming elements. The friction surfaces can be surface portions which are elements of a friction pairing between different components. These can either be directly configured at the respective disc or they can also be configured through an additional liner at the disc. The wet clutch 11 is hydraulically actuatable, thus it includes a shiftable device 14 with at least one actuation element configured with at least one piston element which is loadable with pressure medium, in particular a fluid. The loading with pressure medium is performed through a pressure cavity 8 with the piston element 3. The pressure cavity can be loaded with any pressure, wherein the pressure is typically proportional to the contact pressure of the piston element 3 at the particular clutch discs 1E and 1A. The piston element 3 is thus preferably moveably supported in axial direction at the second clutch component 10A or at an element connected torque proof there with. The support is preferably not performed directly at the second clutch component 10A, but at elements connected torque proof therewith. In the illustrated case this is a housing 15 connected torque proof with the disc support configured as an outer disc support of the second clutch component 10A, wherein the housing encloses the clutch components 10E, 10A in an axial and in a radial direction, forming an inner cavity 20 forming the clutch environment and for receiving the piston element 3, wherein the support of the inner circumference 16 of the piston element 3 is performed at a hub 17 connected torque proof with the housing 15. Thus, the pressure cavity 8 is defined in the illustrated case by the piston element 3, in particular the face 22 of the piston element 3, and the housing 15 coupled with the second clutch component 10A or an element coupled torque proof with the housing, in particular a cylinder component 6 forming a wall or pressure cavity divider. The second clutch component 10A, in particular the outer disc support, can also be configured as a unit with the housing 15. The inner cavity 20 receiving the particular discs 1E and 1A and defined by the inner cavity 18 of the housing 15 and the face 19 of the piston element 3 opposite to the pressure cavity 8 forms the clutch environment. In order to generate a coolant flow also in disconnected condition, this means in an open condition of the shiftable clutch device 10, which is advantageous in particular, when used in hybrid systems, since the discs are dragged along in the operating mode “electric driving”, it is provided according to the invention that the “open” functional position of the piston element 3 is still characterized by a lower pressure in the pressure cavity 8 or in that pressure medium, in particular in the form of oil, is still provided in the pressure cavity 8. It is provided according to the invention for generating a coolant flow that a flow connection is provided between the pressure cavity 8 and the inner cavity 20 forming the clutch environment which is designated herein as 21. Preferably, the flow connection 21 between the pressure cavity 8 and the inner cavity 20 is performed directly through the piston element 3. In the simplest case, openings 2 configured as pass-through openings are provided, which extend between the faces of the piston element 3 disposed opposite to one another. The arrangement is performed, so that the single opening 2 at the face 19 opens in the portion of the piston surface 31 effective at the particular clutch components 10E, 10A.

In order to keep the piston element 3 in its functional position for a small pressure loading, which corresponds to the condition “opened” of the shiftable clutch device 10, the embodiment in FIG. 1A is advantageously characterized in that the force generated through loading the pressure cavity 8 is in equilibrium with a preloading force. The preloading force is applied through a device 32 for generating an actuation force which is oriented opposite to the pressure force in the pressure cavity 8, wherein the device includes at least one preloading element, in particular at least one spring unit 7, in that the piston element 3 is lifted off from the clutch discs 1E and 1A through the spring unit. A low oil pressure is provided in the pressure cavity 8 formed between the piston element 3 and the housing 15, or the cylinder component 6 connected torque proof therewith, wherein the oil pressure generates a force at the face 22, wherein the force is smaller than the reset force of the spring unit 7. The shifting device 14 of the clutch device 10 is thus not without pressure in the “open” functional condition. The cooling medium configured as oil is supplied to the pressure cavity 8 through a connection A1, in particular an oil flow bore hole 4. In this operating condition of the wet clutch 11, thus the operating medium, in particular oil, can flow from the pressure cavity 8 through an opening 2 to the discs 1E and 1A and through the discs 1E and 1A. The opening 2 establishes the connection 21. The oil flow is provided for cooling purposes. Superfluous oil can be provided through an additional connection A2 to the inner cavity 20, in particular configured in the form of at least one oil flow out bore hole 5, and can be provided to an operating medium supply and/or conduction system, in particular to a pump sump, an oil cooler or a pump.

The cooling media flow is illustrated in FIG. 1d for the clutch device 10 illustrated in FIG. 1a.

In the “closed” functional condition of the frictional wet clutch 11, the oil inflow is increased through the connection A1, in particular the oil inflow bore hole 4, so that the piston element 3 is moved against the spring force of the spring unit 7 in a direction of the discs 1E, 1A of the particular clutch components 1E and 1A, and presses them together. Thus, an operative engagement between the clutch components is established and the required torque is transmitted based on the prevailing friction without relative movements between the particular discs. Simultaneously, the connection 21 is deactivated according to the invention, in the simplest case, through closing the opening 2. The opening 2 is thus arranged and aligned in a particularly advantageous manner, so that it contacts one of the discs, in particular the end disc 1.1 in a closed condition of the shiftable clutch device 10 through applying the opening portion to the effective piston surface at the piston face 19. Thus, the cooling media flow generated in an open condition through the opening is interrupted. The functional condition is characterized in that hardly any cooling medium is required, since the heat generated through the friction forces in this functional condition is relatively small.

In the intermediary positions, in particular in slipping operations of the shiftable clutch device 10 and in the piston position of the piston element 3 thus caused, the opening 2 is then only partially or conditionally closed. This generates a lower cooling media flow, than in open condition. This cooling media flow is then adapted to the condition of the friction forces. The higher the possible friction forces, the higher the cooling medium flow, in particular the cooling oil flow.

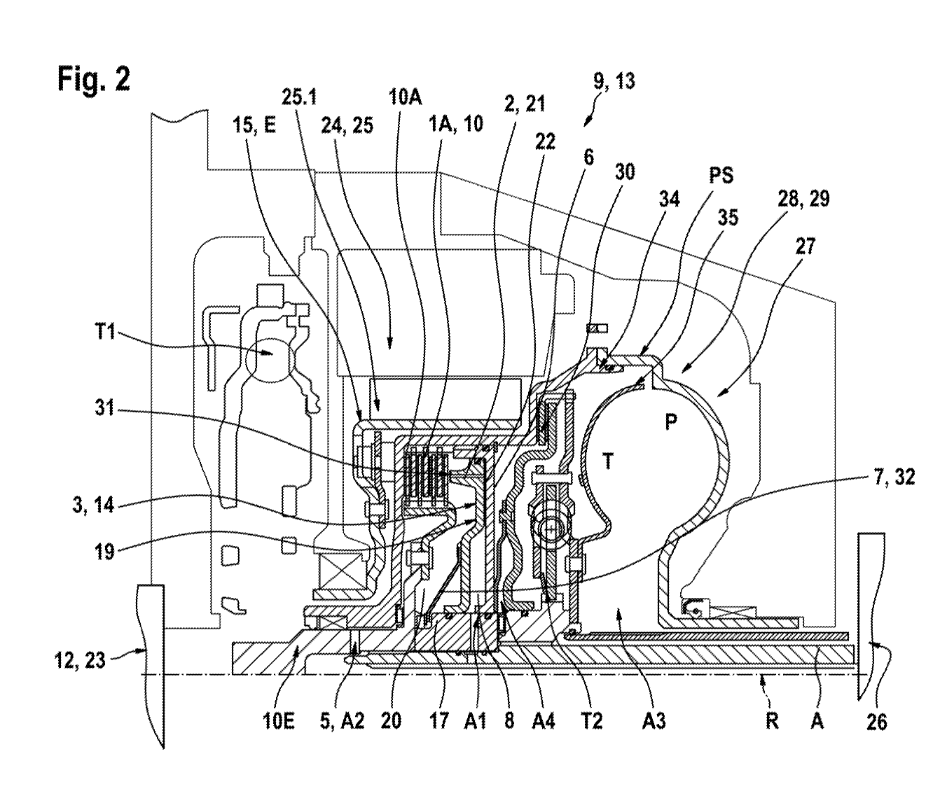

FIG. 2 illustrates a particularly advantageous embodiment of a shiftable clutch device 10 configured according to the invention, in particular a friction wet clutch 11 in a drive train 13 for a hybrid system 9 for use in vehicles. The drive train includes a first drive machine 12, which is configured as an internal combustion engine 23 in a particularly advantageously embodiment and an additional second drive machine or drive unit 24, which is configured as an electrical machine 20, which is operable at least as a motor and/or generator, whose rotor 25.1 is connected torque proof with the drive train 13. The coupling of the particular drive machines 12 and 24 with a consumer, in particular configured as a transmission 26 of the drive train 13, and the remaining components coupled therewith up to the wheels is performed through a first transmission device 27, including an input E and an output A, and at least one startup element 28 disposed there between, and possibly an additional device T2 for damping vibrations. The startup element 28 can be configured as a hydrodynamic component 29 or as a clutch 30, in particular a shiftable clutch device. The hydrodynamic component 29 is configured in a particularly preferred embodiment as a hydrodynamic speed-/torque converter. It is used for simultaneously converting speed and torque in a predefined ratio to one another. The hydrodynamic speed-/torque converter thus includes a primary shell functioning as a pump shell in the force flow between one of the drive machines 12, 24 and the consumer 26 configured as a transmission, and a secondary shell functioning as a turbine shell T, at least one reactive element configured as a stator shell, which can be supported fixated or also rotatable. It is furthermore conceivable to also configure the hydrodynamic component as a hydrodynamic clutch. In this case, the hydrodynamic clutch only includes a primary shell functioning as a pump shell P, and a secondary shell functioning as a turbine shell T. The hydrodynamic clutch does not include a stator shell and is only used for speed conversion with a moment transmitted unchanged. The force transmission device 27 then additionally includes a shiftable clutch device 30 for circumventing the force flow through the hydrodynamic component 29, in order to facilitate using the power transmission through the hydrodynamic component only in ranges of high efficiency, and to bridge them in the operating ranges which are characterized by the interaction with the operating range of the respective drive machine through a low efficiency. Shiftable clutch devices of this type are configured in the form of friction clutches, preferably disc clutches. They can be operated with slippage. However, it is also conceivable to use synchronously shiftable clutches. Thus, the force flow can be respectively run from one of the drive machines 12 or 24 through the force transmission device 27 to the transmission 26 or by both together, in that both drive machines 12, 24 are operated in parallel. In order to facilitate an exclusive force transmission through the second drive machine 24 to a consumer configured as a transmission 26, a device for selectively interrupting the force flow is provided between the first drive machine 12, in particular the internal combustion engine 23 and the force transmission device 27, wherein the device is preferably provided in the form of a shiftable clutch device 10, in particular a friction wet clutch 11 according to FIGS. 1a, 1b. The clutch device 10 is thus also designated as an engine clutch and is used for interrupting or providing a force flow between the first drive machine 12 and the subsequent drive train 13. The first clutch component 10E is therefore connected at least indirectly torque proof with the first drive machine 12, while the second clutch component 10A is connected at least indirectly torque proof with the input E of the force transmission device 27. In the illustrated case, the coupling of the first clutch component 10E with the first drive machine 12 is performed through a vibration damper T1, in particular an elastic clutch. Coupling the second clutch component 10A with the input E of the force transmission device 27 is preferably performed directly, in particular through integral configuration of the outer disc support with the housing 15. With respect to the particular embodiments, there is a plurality of options. Typically, the force transmission device 27 is designed, so that it does not include an independent housing, but the pump shell PS, which is configured at the pump shell P, is connected torque proof with a housing bell 34, which extends in axial direction forming an inner cavity 35 for receiving the shiftable clutch device 30, wherein the housing bell 34 can be configured depending on the embodiment, so that it also forms the housing 15 of the shiftable clutch device 10. In this case, an intermediary wall for dividing the particular pressure cavities between the force transmission device 27 and the shiftable clutch device 10 only has to be provided within the housing bell 34 in the form of a pressure cavity divider, which can be formed by the cylinder component 6.

The solution according to the invention is usable in a particularly advantageous manner in an embodiment of a drive train 13 in the form of a hybrid system 9 with a force transmission device 27 in two-channel configuration. This means that the force transmission device has at least connections A3 and A4 and the operating media conduction in the particular operating modes is performed, so that the actuation of the shiftable clutch device 30 is controllable through the pressures at the two connections A3, A4. The first connection A3 is connected with an operating cavity formed by the hydrodynamic component 29, while the second connection A4 is connected with an inner cavity 35 formed between the outer circumference of the hydrodynamic component 29 and the coupling of the pump shell P with the input E of the force transmission device 27 and the housing bell 34. Depending on the operating mode of the force transmission device 27, the hydrodynamic component 29 is thus flowed through either in a centripetal or centrifugal manner. In the first case, the operating medium routing is performed quasi through the second connection A4 between the particular clutch components of the shiftable clutch device 30 using a respective opening pressure for the clutch device 30 towards an outer circumference of the hydrodynamic component 29, while filling the hydrodynamic component and generating a flow cycle in the operating cavity. In the second operating mode of the force transmission device 27, the hydrodynamic component is flowed through in a centrifugal manner, wherein the pressure at the shifting device of the shiftable clutch device 30 is increased and the shiftable clutch device 30 is closed. Both operating modes can be performed with the first drive machine 12 and also with the second drive machine 24. In an improved embodiment, which is not illustrated herein, the force transmission device 27 can also be provided in a three-channel configuration. In this case, the shifting device of the shiftable clutch device 30 can be actuated through a pressure cavity associated with the clutch device, wherein the pressure cavity can be loaded with any pressure.

### REFERENCE NUMERALS AND DESIGNATIONS

1E, 1A clutch discs
1.1 end disc
2 opening, pass-through opening
3 piston element
4 oil inlet bore hole
5 oil outlet bore hole
6 cylinder component
7 spring unit
8 pressure cavity
9 hybrid system
10 shiftable clutch device
10E first clutch component
10A second clutch component
11 wet clutch
12 first drive machine
13 drive train
14 shifting device
15 housing
16 inner circumference
17 hub
18 inner circumference
19 face
20 inner cavity
21 connection
22 face
23 internal combustion engine
24 second drive machine
25 electrical machine
25.1 rotor
26 transmission
27 force transmission device
28 startup element
29 hydrodynamic component
30 shiftable clutch device
31 effective piston surface
32 device for generating a force that is opposite to the pressure force in the pressure cavity
34 housing bell
35 inner cavity
A1-A4 connections
A output
E input
P pump shell
T turbine shell
T1, T2 vibration damper
PS pump shell

1. A shiftable clutch device (10), in particular in disc configuration, comprising at least a first clutch component (10E) and a second clutch component (10A), each clutch component including friction surface bearing and/or friction surface forming elements (1E, 1A, 1.1), configured to be brought into at least indirect operative engagement through a shifting device (14) that is loadable with a pressure medium through a pressure cavity (8), wherein devices for generating a cooling oil flow to the friction surface bearing and/or friction surface forming elements (1E, 1A, 1.1.) of the particular clutch components (10E, 10A) are provided in an “open” functional condition of the shiftable clutch device (10).

2. The shiftable clutch device (10) according to claim 1, wherein the shiftable clutch device is configured as friction wet clutch (11).

3. The shiftable clutch device (10) according to claim 1, wherein the devices for generating a cooling oil flow include a flow connection (21) at least between the pressure cavity (8) and the surroundings of the particular clutch components (10E, 10A) and include devices for controlling the fluid flow through the flow connection (21).

4. The shiftable clutch device (10) according to claim 1, wherein the devices for controlling the fluid flow as a function of the position of the control device (14), in particular the piston element (3), include at least a controllable valve device, in particular a throttle.

5. The shiftable clutch device (10) according to claim 1, wherein the shifting device (14) includes at least a piston element (3), which is supported axially movable at one of the two clutch components (10E, 10A) and/or an element (6, 17) connected torque proof therewith, while forming the pressure cavity (8) that is loadable with pressure medium, and the flow connection (21) is provided through at least one opening (2) extending through the piston element (3), whose pass-through cross section is controllable.

6. The shiftable clutch device (10) according to claim 5, wherein a plurality of openings (2) is provided that are offset from one another in a circumferential direction.

7. The shiftable clutch device (10) according to claim 1, wherein the shifting device (14) includes at least a piston element (3), which is supported axially movable at one of the two clutch components (10E, 10A) or at an element connected torque proof therewith while forming the pressure cavity (8), which is loadable with the pressure medium, and the flow connection (21) includes at least one recess in the pressure cavity (8) and/or in the wall of the piston element (3) towards the particular friction surface bearing and/or friction surface forming elements (1E, 1A, 1.1) of the clutch components (10E, 10A) of the shiftable clutch device (10).

8. The shiftable clutch device (10) according to claim 7, wherein the recess in the piston element (3) is preferably provided in the piston base.

9. The shiftable clutch device (10) according to claim 5, wherein the particular opening (2) and/or the recess are closable in a “closed” functional condition of the shiftable clutch device (10).

10. The shiftable clutch device (10) according to claim 9, wherein the particular opening (2) and/or recess is closable through an element of the shiftable clutch device (10).

11. The shiftable clutch device (10) according to claim 10, wherein the element is formed by a friction surface bearing and/or friction surface forming element (1E, 1A, 1.1), in particular an end disc (1.1) of the shiftable clutch device (10).

12. The shiftable clutch device (10) according to claim 5, wherein the particular opening (2) opens at the piston element (3) in the portion of the piston surface (31) that is effective at the friction surface bearing and/or friction surface forming elements (1E, 1A, 1.1), and controlling the pass-through cross section is performed by controlling the contact force applicable at the clutch components (10E, 10A) through the effective piston surface (31).

13. The shiftable clutch device (10) according to claim 5, wherein the piston element (3) is axially supported at the second clutch component (10A) of the shiftable clutch device (10) or at a component connected torque proof therewith.

14. The shiftable clutch device (10) according to claim 13, wherein the second clutch component (10A) includes an outer disc support which is disposed at a rotatable housing (15) or which forms an integral unit with the rotatable housing, and the piston element (3) is supported axially movable at the housing (15), at a wall connected torque proof with the housing (15), or at an element (6) connected torque proof with the housing (15).

15. The shiftable clutch device (10) according to claim 5, wherein the piston element (3) is axially supported at the first clutch component (10A) of the shiftable clutch device (10) or at a component connected torque proof therewith.

16. The shiftable clutch device (10) according to claim 5, wherein the piston element (3) is loaded with low pressure in an “open” functional condition of the shiftable clutch device (10) and is supported in this position through a device (32) for generating a force that is oriented opposite to a pressure force in the pressure cavity (8), including preferably at least a preloading element in the form of a spring unit (7).

17. A drive train (13) for a hybrid system (9), in particular for application in vehicles with at least two drive machines (12, 24), which are configured to be coupled with additional transmission units (26) through a force transmission device (27), wherein a device for providing/disconnecting a force flow between the first drive machine (12) and the drive train (13) is provided, including a shiftable clutch device (10) according to claim 1.

18. The drive train (13) according to claim 17, wherein the force transmission device (27) includes a hydrodynamic component (29) and a device for at least partially circumventing a power flow through the hydrodynamic component (29), which are disposed between the input (E) and the output (A) of the force transmission device (27).

19. The drive train (13) according to claim 18, wherein the hydrodynamic component (29) is configured as a hydrodynamic speed-/torque converter or as a hydrodynamic clutch.

20. The drive train (13) according to claim 18, wherein the force transmission device (27) is configured as a two-channel unit.

21. The drive train (13) according to claim 18, wherein the force transmission device (27) is configured as a three-channel unit.

22. The drive train (13) according to claim 17, wherein the first drive machine is formed by an internal combustion engine (23) and the second drive machine (24) is formed by an electrical machine (25), which is configured to be operated as a motor or a generator.

23. A vehicle comprising a drive train according claim 17.
